(19) United States
(12) Patent Application Publication
(10) Pub. No.: US 2025/0187127 A1
(43) Pub. Date: Jun. 12, 2025

(54) MOUNTING ASSEMBLY, POSITIONING DEVICE WITH SUCH A MOUNTING ASSEMBLY AND DEVICE FOR PRODUCING SUCH A MOUNTING ASSEMBLY

(71) Applicant: PHYSIK INSTRUMENTE (PI) SE & CO. KG, Karlsruhe (DE)

(72) Inventors: Michael EBERT, Karlsruhe (DE); Christian SANDER, Karlsbad (DE); Philipp MAHL, Waghäusel (DE)

(21) Appl. No.: 18/842,175

(22) PCT Filed: Feb. 27, 2023
(86) PCT No.: PCT/EP2023/054849

§ 371 Date: Aug. 28, 2024

(30) Foreign Application Priority Data
Mar. 3, 2022 (DE) 10 2022 104 991.4

(51) Int. Cl. B23P 19/10

(52) U.S. Cl. CPC B23P 19/10

(57) ABSTRACT

A mounting assembly is provided for the articulated mounting of an actuator in a positioning device. In order to enable a simpler manufacturing and mounting process and in particular to facilitate the exchange of actuators in an existing structure or installation of the positioning device, the mounting assembly comprises a joint device, a bearing supporting a part or an element of the joint device, and a bearing seat connected to the bearing in a detachable manner. A positioning device with such a mounting assembly and a device for producing such a mounting assembly are also provided.

### CROSS REFERENCE TO RELATED APPLICATIONS

This application is a 371 U.S. National Phase of International Application No. PCT/EP2023/054849, filed on Feb. 27, 2023, which claims priority to German Patent Application No. 10 2022 104 991.4, filed Mar. 3, 2022. The entire disclosures of the above applications are incorporated herein by reference.

### BACKGROUND

### Technical Field

The present invention relates to a mounting assembly for the articulated mounting of an actuator in a positioning device, a positioning device with such a mounting assembly and a device for producing such a mounting assembly.

### Related Art

A known case of application for the articulated mounting of an actuator is a positioning device that comprises a base and an object carrier, where one or more actuators are arranged between the base and the object carrier and the orientation and position of the object carrier relative to the base can therefore be adjusted accordingly. The actuators can be in particular linear actuators that are connected to the base or object carrier, respectively, by a universal joint. Such a configuration can be found, for example, in hexapods, in which the object carrier is connected to the base by way of six actuators.

FIG. 1 shows a mounting assembly for the articulated mounting of an actuator 10 on a base 11 of a positioning device according to prior art. There are recesses disposed in base 11 and in object carrier 12 that directly receive corresponding joint axes 8a of universal joints 8 connected to actuators 10. Joint axes 8a must be aligned in the corresponding recesses in base 11 or object carrier 12 for mounting and thereafter affixed with an additional element in order to ensure a high level of absolute accuracy of the positioning device.

The following disadvantages arise: the introduction of the recesses in the form of semicircular grooves in the base and object carrier 11, 12 makes production complex. As already mentioned above, joint axes 8a of universal joints 8 must be aligned in the recesses in base 11 and object carrier 12 when actuators 10 are mounted in the positioning device, which is a complex process and cannot be carried out easily in the field, i.e. with an existing structure on the positioning device or when the positioning device is installed in a higher-level structure. Screws that are required to affix joint axes 8a to base 11 or object carrier 12 are typically only accessible from the top or bottom of base 11 or object carrier 12. This makes it difficult to mount actuators 10 in the overall system and makes it partially impossible to exchange actuators 10 in the field.

### SUMMARY

Due to the disadvantages described above, an object of the present invention is to provide a mounting assembly for the articulated mounting of an actuator in a positioning device which enables a simpler manufacturing and mounting process and in particular facilitates the exchange of actuators in an existing structure or installation of the positioning device.

This object is satisfied by a mounting assembly comprising a joint device that can be coupled to the actuator, a bearing that supports the joint device or a part or an element of the joint device, and a bearing seat that is detachably connected to the bearing.

A wide variety of configurations is conceivable for the joint device: for example, those with articulation elements in which corresponding parts slide and/or roll against each other, such as in classic or conventional rotary or ball joints. In addition, joint devices are conceivable which have flexure hinges or spring joints. Combinations of different types of joints are also conceivable for the joint device. In a preferred embodiment, the joint device is a universal joint.

The bearing provides a separate component that receives the joint device or a part or element of the joint device, respectively. The bearing can be pre-assembled with the joint device in this manner. Furthermore, the joint device or a part or element thereof is connectable to the actuator. To install an actuator pre-assembled with the bearing and the joint device in the positioning device, the bearing only needs to be positioned in the bearing seat and secured, i.e. be connected to the bearing seat. Similarly, an actuator can be removed simply by releasing the connection between the bearing and the bearing seat.

The use of the term ‘or’ in connection with features of the object of the invention should presently be understood—unless explicitly stated otherwise—to be a non-exclusive ‘or’ or a non-exclusive disjunction, respectively.

It can be advantageous to have the bearing and the bearing seat be configured as complementary male and female coupling sections that can be moved between an uncoupled state and a coupled state and interact in a positive-fit manner at least in sections in the coupled state, where the bearing preferably forms the male coupling section and the bearing seat forms the female coupling section, or vice versa. A positive interaction of the bearing and the bearing seat can achieve a coupled state in which some degrees of freedom of the bearing relative to the bearing seat are already blocked, which facilitates the pre-positioning of the bearing in the bearing seat.

It can be useful to have the female coupling section form a housing for receiving the male coupling section, where the housing encloses the male coupling section at least in sections in the coupled state.

It can prove useful to have the mounting assembly comprise at least one securing device to secure the bearing and the bearing seat to one another in the coupled state, the securing device preferably comprising:
a. a spring device, in particular as a primary securing device, to force the bearing and the bearing seat into the coupled state in a spring-loaded manner; and/or
b. a locking device, in particular as a secondary securing device, to lock all degrees of freedom of motion of the bearing relative to the bearing seat in a positive-fit manner in the coupled state, preferably without play, where the locking device preferably acts in a force-fit manner, particularly preferably in two different directions.

With such a securing device, the coupled state can gradually be converted to a connected state. This means that the degrees of freedom of the bearing relative to the bearing seat that are not yet blocked in the coupled state are blocked by the spring device and the locking device, whereby the bearing can be connected to the bearing seat reliably and in a precise position.

It can be advantageous to have the bearing comprise a flat contact surface which, in the coupled state, is in contact with a flat contact surface of the bearing seat, where the bearing abuts against at least one abutment section of the bearing seat which protrudes beyond the contact surface of the bearing seat and is preferably aligned perpendicular to the contact surface of the bearing seat. This already blocks some of the bearing's degrees of freedom relative to the bearing seat, thereby achieving the pre-positioning of the bearing in the bearing seat.

It can prove to be practical to have the bearing be drawn against a first abutment section of the bearing seat by a screw and/or be pressed against a second abutment section of the bearing seat by way of a spring, where the first abutment section and the second abutment section of the bearing seat are preferably aligned perpendicular to one another. Due to the positional fixation carried out in this manner, a high level of repeatability of the mounting process can be ensured. In addition, mounting in the field is simplified because the bearing aligns by itself to a certain extent in the bearing seat.

It can also be advantageous to have the joint device be configured as a universal joint with two non-parallel joint axes, where one of the joint axes is supported by the bearing and the other of the joint axes can be coupled to the actuator. Using universal joints, accurate and precise support of the actuator can be achieved in a comparatively simple manner which allows the actuator to be tilted or pivoted about two tilt or rotational axes arranged perpendicular to one another.

It can be useful to have the bearing comprise two oppositely disposed axis seats, each of which receives an end section of the supported joint axis of the universal joint.

It can be advantageous to have the bearing receive the supported joint axis of the universal joint in a force-fit manner, in particular by clamping, and/or be connected to the supported joint axis of the universal joint in a positive substance-fit manner, in particular by adhesive bonding or welding. The selection of the type of connection depends on the case of application. A clamp connection can be used to provide a detachable connection if separation of the universal joint and the bearing should basically be possible. On the other hand, a permanent and reliable connection can be achieved by way of a positive substance-fit connection.

It can be useful to have the bearing comprise at least one multi-part axis seat, the parts of which are connected to one another by at least one screw connection for clamping an end section of the supported joint axis of the universal joint, where the longitudinal axis of the screw connection preferably encloses an angle other than 90° with a flat contact surface of the bearing. With such an axis seat, the universal joint can be connected to the bearing in a detachable manner. The aforementioned alignment of the longitudinal axis of the screw connection improves accessibility to the screw connection.

A further aspect of the present invention relates to a positioning device comprising a base, an object carrier, and at least one actuator arranged therebetween, where the at least one actuator is connected to the base or the object carrier by the mounting assembly according to one of the preceding embodiments, where the bearing seat is integrally connected to the base or the object carrier.

In such a positioning device, the actuators can be easily installed and removed or exchanged, respectively.

It can be advantageous to have the bearing seat integrally connected to the base or the object carrier. This makes it easier in particular to mount the positioning device.

It can additionally be advantageous to have the bearing seat be configured as a recess in the surface of the base on the actuator side or in the surface of the object carrier on the actuator side. In this manner, a space-saving arrangement of the bearing in the bearing seat can be realized, which at the same time leads to weight saving for the base or the object carrier and thereby to a lighter positioning device.

It can prove useful to have the bearing be connected to the bearing seat by at least one screw connection, where the longitudinal axis of which runs in a direction parallel to a surface of the base or the object carrier on the actuator side. This improves accessibility to the screws. The actuators can therefore also be installed and removed in an existing structure or installation of the positioning device, in particular for the reason that the base and the object carrier can remain in their position and orientation.

It can be advantageous to have the recess, as which the bearing seat is configured, extend beyond an edge of the base or the object carrier. This allows the bearing to be inserted into the bearing seat in a simple manner.

It can be useful to have the positioning device be a parallel kinematic positioning device and preferably a hexapod comprising six actuators.

A further aspect of the present invention relates to a device for mounting an actuator in a positioning device, in particular for producing a mounting assembly according to one of the preceding embodiments, comprising a main body which is preferably configured as a handle and at least one holding section which is connected to the main body and is configured to hold a joint device which is coupled to a bearing and to the actuator, and to hold the bearing in a rotationally locked manner. In a known type of linear actuator, a rotational motion is converted into a translational motion by way of a spindle. If such an actuator does not have any reference switch, then care must be taken when handling the actuator until mounting in the positioning [sic] to ensure that the part of the actuator on the output side is not rotated by a full spindle revolution, otherwise the set actuator length will deviate by the amount of the spindle pitch. The above-mentioned device can simplify handling of an actuator during the mounting process. In particular, it can be used to position an actuator pre-assembled with the bearing for mounting between the base and the object carrier, preventing the part of the actuator on the output side from rotating.

It can be practical to have the holding section comprise a clamp and a support section, where the clamp is configured to hold the joint device in a rotationally locked manner and the support section is configured to support the bearing in a rotationally locked manner.

It can be useful to have the clamp be integrally connected to the main body or detachably attached to the main body. An integral connection of the main body to the clamp can be realized inexpensively and in a simple manner in an injection molding process. A clamp detachably connected to the main body provides the advantage of exchangeability. This means that different clamps can be attached to the main body, where the size and shape of the respective clamp can be matched to the size of the universal joint.

### BRIEF DESCRIPTION OF THE DRAWINGS

FIG. 1 shows a mounting assembly for the articulated mounting of an actuator on a base of a positioning device according to prior art.

FIG. 2 shows a mounting assembly for the articulated mounting of an actuator on a base of a positioning device according to an embodiment of the present invention.

FIG. 3 shows a bearing of the mounting assembly according to the invention connected to a universal joint in a side view.

FIG. 4 shows a bearing of the mounting assembly according to the invention connected to a universal joint in a perspective view.

FIG. 5 shows a sectional view of an embodiment of the mounting assembly according to the invention.

FIG. 6 shows a detailed view of the base of the positioning device which comprises a bearing seat and a spring device (primary securing device).

FIG. 7 shows a device for mounting an actuator in a positioning device.

FIG. 8 shows the device of FIG. 7 when an actuator is mounted between a base and an object carrier of the positioning device.

FIG. 9 shows the device of FIG. 7 in which clamps for holding the universal joints are integrally connected to a main body of the device.

FIG. 10 shows an alternative embodiment of the device in which clamps for holding the universal joints are attached to a main body of the device in a detachable manner.

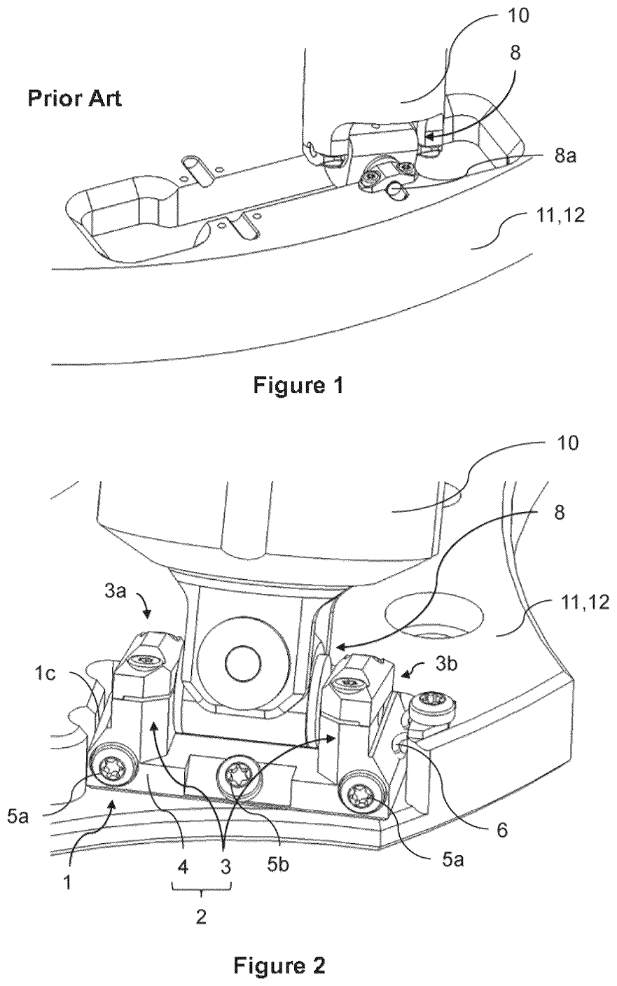

### DETAILED DESCRIPTION

A preferred embodiment of the present invention is described in detail below with reference to FIGS. 2 to 6.

The mounting assembly comprises a bearing 2, a universal joint 8 with two non-parallel joint axes 8a, 8b, of which one joint axis 8a is received by bearing 2, and a bearing seat 1, to which bearing 2 is connected in a detachable manner. Other joint axis 8b of universal joint 8 is connected to an actuator 10.

Bearing 2 and bearing seat 1 are configured to be complementary to one another, at least in sections. In particular, bearing seat 1 is formed by a preferably cuboid-shaped recess in a surface of a base 11 or an object carrier 12. Bearing 2 comprises a connection section 4 which is preferably configured as a cuboid-shaped base and is therefore fitted into bearing seat 1 at least in sections in a positive-fit manner. Bearing 2, in particular connection section 4, therefore corresponds to a male coupling element. Bearing seat 2 corresponds to a female coupling element. When bearing 2 is fitted into bearing seat 1, bearing 2 and bearing seat 1 are in a coupled state in which at least some translational and/or rotational degrees of freedom of bearing 2 relative to bearing seat 1 are blocked.

In particular, bearing seat 1 comprises a flat (main) contact surface 1a which, in the coupled state, is in contact with a flat (main) contact surface 4a of connection section 4 of bearing 2 as intended. (Main) contact surface 4a of bearing 2 forms the underside of cuboid-shaped connection section 4. Bearing seat 1 furthermore comprises at least two abutment sections 1b, 1c which protrude in a vertical direction beyond (main) contact surface 1a of the bearing seat (1). In addition, two abutment sections 1b, 1c are aligned perpendicular to each other and therefore, in conjunction with (main) contact surface 1a of bearing seat 1, form a type of half-open housing which receives bearing 2, in particular connection section 4, at its corresponding sections in a positive-fit manner.

In the preferred embodiment, bearing seat 1 is formed as a cuboid-shaped recess in a surface of base 11 or object carrier 12. Of course, the recess can also have a different shape. In order to establish a coupled state, however, it is advantageous in any case to have bearing 2 and bearing seat 1 have shapes that are complementary to each other. Furthermore, bearing seat 1 does not have to be formed by a recess, but can also be formed, for example, by corresponding stops that are provided on the surface of base 11 or object carrier 12.

Furthermore, the mounting assembly comprises a securing device 5a, 5b, 6 which, in the coupled state, secures bearing 2 and bearing seat 1 to one another. Securing device 5a, 5b, 6 includes a spring device (spring) 6 which represents a primary securing device and resiliently forces bearing 2 and bearing seat 1 to the coupled state. As can be seen from FIGS. 2 and 6, spring device (spring) 6 is arranged on a section of bearing seat 1 that is disposed opposite abutment section 1c of bearing seat 1. Spring 6 is affixed to bearing seat 1 with a screw. Spring 6 is shaped such that it presses onto a lateral section of bearing 2 and then forces bearing 2 against abutment section 1c of bearing seat 1. The lateral section of bearing 2, onto which spring 6 presses, is preferably not arranged perpendicular to (main) contact surface 4a of bearing 2, but is configured as an inclined plane. Bearing 2 then experiences not only a horizontal force from spring 6, which presses bearing 2 against abutment section 1c of bearing seat 1, but also a vertical force, which presses bearing 2 against (main) contact surface 1a of bearing seat 1.

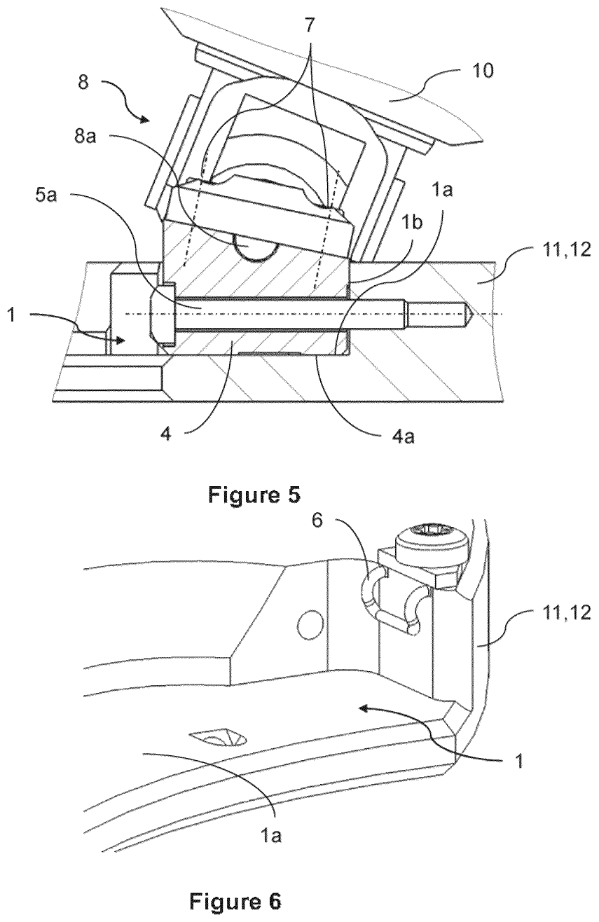

In addition, securing device 5a, 5b, 6 includes a locking device 5a, 5b, which represents a secondary securing device and locks all degrees of freedom of motion of bearing 2 relative to bearing seat 1 in the coupled state in a positive-fit manner and without play. In particular, locking device 5a, 5b is screws 5a, 5b which affix bearing 2 in bearing seat 1. Two screws 5a penetrate bearing 2 in a direction parallel to the (main) contact surface and are screwed into corresponding threaded holes that extend from abutment section 1b (see FIG. 5). Screws 5a therefore initially force bearing 2 against abutment section 1b before finally affixing bearing 2 in this position in bearing seat 1 in a force-fit manner. Furthermore, locking device 5a, 5b comprises an additional screw 5b which penetrates bearing 2 and in particular (main) contact surface 4a in an oblique direction and is screwed into a threaded hole which extends in this oblique direction from (main) contact surface 1a of bearing seat 1. The longitudinal axis of screw 5b encloses an angle of 45° with (main) contact surface 1a, where angle ranges between 3° and 50° are presently conceivable. The final position of bearing 2 in bearing seat 1 can be affixed by way of screw 5b.

It is conceivable that the longitudinal axes of screws 5a run in a non-parallel direction to (main) contact surface 1a of bearing seat 1, where the angles which the longitudinal axes of screws 5a form with (main) contact surface 1a can be in a range of +/−50°.

In addition to connection section 4, bearing 2 comprises a seat portion 3 for receiving joint axis 8a of universal joint 8. Seat portion 3 is formed by two oppositely disposed axis seats 3a, 3b, each of which receives an end section of supported joint axis 8a of universal joint 8. Seat portion 3 or axis seats 3a, 3, respectively, is/are formed integrally with connection section 4.

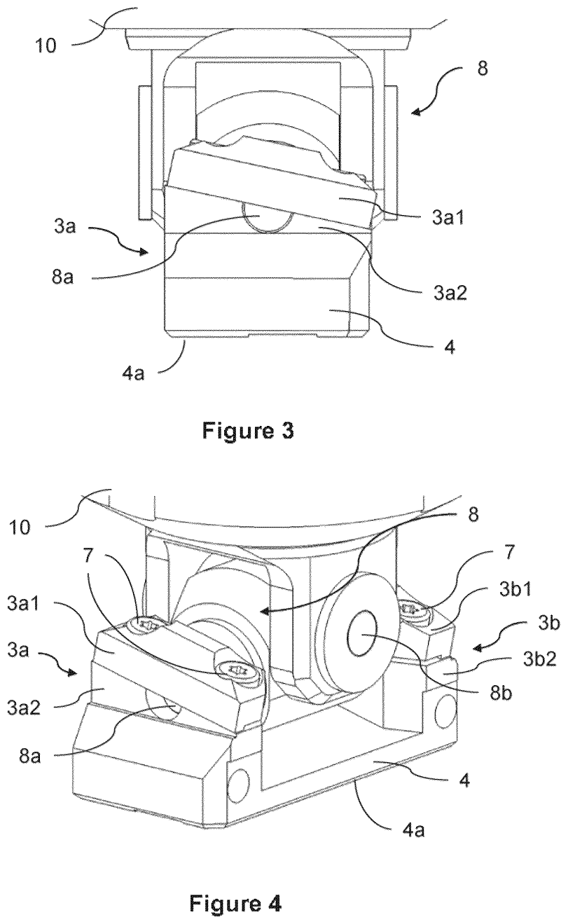

Axis seats 3a, 3b are each multi-part axis seats 3a1, 3a2, 3b1, 3b2 with an upper part 3a1, 3b1 and a lower part 3a2, 3b2 (see FIGS. 3 and 4). Upper part 3a1, 3b1 and lower part 3a2, 3b2 of each axis seat 3a, 3b are connected to one another by two screws 7 such that they clamp an end section of supported joint axis 8a of universal joint 8. The respective longitudinal axis of these screws 7 encloses an angle other than 90° with (main) contact surface 4a of bearing 2 (see FIG. 5). Such an alignment of the screw axes is realized in particular in that an upper side of lower part 3a2, 3b2 and/or upper part 3a1, 3b1 does not run parallel to (main) contact surface 4a of bearing 2. In the case of an approximately cuboid-shaped upper part 3a1, 3b1, this can be achieved, for example, in that a contact plane between upper part 3a1, 3b1 and lower part 3a2, 3b2 is not parallel to (main) contact surface 4a of bearing 2. The alignment of the screw axes described above improves accessibility to screws 7, since the use of corresponding tools is not obstructed by universal joint 8 or actuator 10 connected thereto.

In addition to a force-fit reception of joint axis 8a by clamps, joint axis 8a can also be connected to axis seats 3a, 3b in a positive substance-fit manner, i.e. by adhesive bonding or welding. A combination of a force-fit and positive substance-fit seat is also conceivable.

A further aspect of the invention relates to a positioning device 9 which comprises the mounting assembly according to the invention. Such a positioning device 9 shall be described hereafter with reference to FIG. 8. FIG. 8 shows the mounting of an actuator 10 between base 11 and object carrier 12 of positioning device 9. For the sake of illustration, only one actuator 10 is shown in FIG. 8, where a total of six actuators are provided for positioning device 9 presently shown, i.e. an assembly of two respective actuators is provided for each bearing seat 1 formed in base 11 or object carrier 12. In principle, however, positioning device 9 can also comprise fewer than three or more than three actuators 10. In a preferred case, positioning device 9 is a parallel kinematic positioning device and particularly preferably a hexapod. In this case, positioning device 9 comprises six actuators 10 which are arranged between base 11 and object carrier 12.

According to the invention, it is provided that at least one of actuators 10 is connected to base 11 or object carrier 12 by the mounting assembly described above. Actuator 10 is coupled to joint axis 8b of universal joint 8. Bearing seat 1 is connected integrally to base 11 or object carrier 12, respectively. In particular, bearing seat 1 is configured as a recess in a surface of base 11 or object carrier 12 on the actuator side. As can be seen from FIGS. 2 and 8, the recess extends beyond an edge of base 11 or object carrier 12, respectively. This means that bearing seat 1 is accessible from a peripheral side of base 11 or object carrier 12, respectively. In the case of an approximately round base 11 or a round object carrier 12, respectively, as shown in FIG. 8, this corresponds to accessibility from the radial direction. In a case in which base 11 and object carrier 12 are disposed in an existing structure, i.e. in a case in which the distance between base 11 and object carrier 12 is already approximately defined, such an assembly of the recesses has the advantage that bearings 2 connected to actuator 10 can be pushed into bearing seat 1 in a simple manner.

Furthermore, the longitudinal axes of screws 5a described above run in a direction parallel to the surface of base 11 or object carrier 12 on the actuator side or parallel to contact surface 1a of bearing seat 1, respectively. In contrast, the longitudinal axis of screw 5b runs in a non-parallel direction to the surface of base 11 or object carrier 12 on the actuator side and at the same time in a non-parallel direction to contact surface 1a of bearing seat 1, where the direction of the longitudinal axis of screw 5b encloses an angle of 45° with the surface of base 11 or object carrier 12 on the actuator side or contact surface 1a of the bearing seat. This ensures peripheral accessibility or accessibility from the radial direction to screws 5a and 5b. The mounting of bearing 2 in bearing seat 1 is therefore facilitated and in particular is not obstructed by actuator 10 itself.

The above-mentioned alignment of the longitudinal axes of screws 5a and 5b is described with reference to the alignment of the surface of base 11 or object carrier 12 on the actuator side. Alternatively, it is suggested to specify the alignment of the longitudinal axes of screws 5a and 5b with reference to a main axis of the positioning device. The main axis of the positioning device is a central axis that intersects base 11 and object carrier 12. In the initial state, i.e. in the non-deflected state of the positioning device, base 11 and object carrier 12 are aligned parallel to each other and perpendicular to the main axis. In the typical case of application, the main axis runs vertically and base 11 lies in a horizontal plane (see FIG. 8). Good accessibility to screws 5a and 5b is generally achieved in the present positioning device by the longitudinal axes of screws 5a and 5b each being aligned within an angular range of +/−50° to an orthogonal line of the main axis of the positioning device. In the typical case of application described above, the orthogonal line of the main axis is therefore aligned horizontally and parallel to base 11. Of course, there are cases of application in which the positioning device is installed in an inclined state, where the main axis is not aligned vertically.

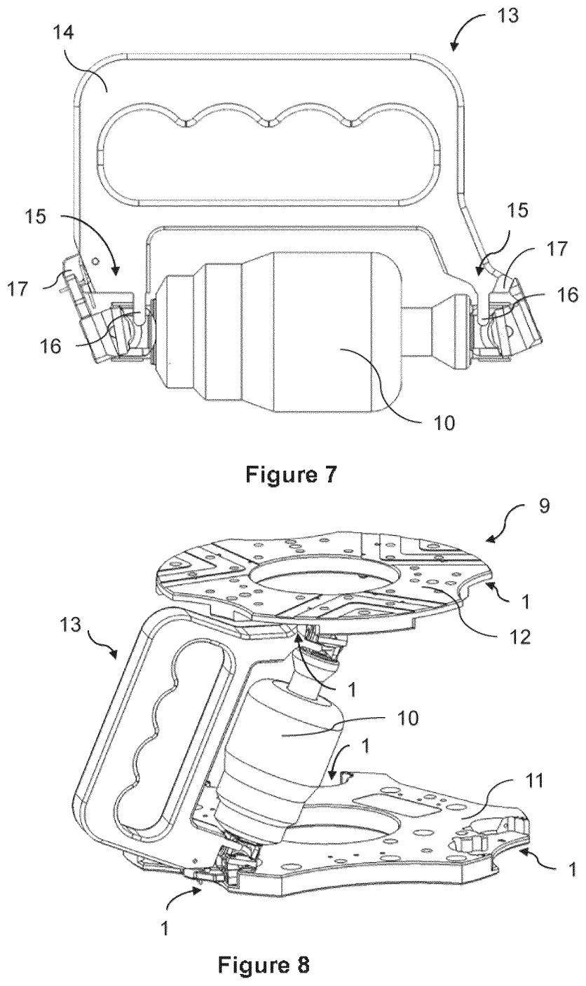

A further aspect of the present invention relates to a device 13 for mounting an actuator 10 in a positioning device 9. In particular, the mounting assembly according to the invention can be produced quickly and in a simple manner using such a device 13. As can be seen from FIG. 7, device 13 comprises a main body 14, which is configured as a handle, and two holding sections 15 connected to main body 14. Holding sections 15 are configured to hold universal joint 8, which is coupled to a bearing 2 by way of its first joint axis 8a and to actuator 10 by way of its second joint axis 8b, and bearing 2 in a rotationally locked manner. As shown in FIG. 8, the rotationally locked fixation of bearing 2 allows bearing 2 pre-assembled with actuator 10 to be pre-aligned such that it can be fitted into bearing seat 1 in a simple manner. This fixation is particularly advantageous when an actuator 10 is to be mounted between a base 11 and an object carrier 12 and then has a pre-assembled bearing 2 at both of its ends. This means that when actuator 10 is positioned between base 11 and object carrier 12 using device 13, bearings 2 can be aligned in the corresponding bearing seats 1 in a simple manner due to their anti-rotation pre-alignment.

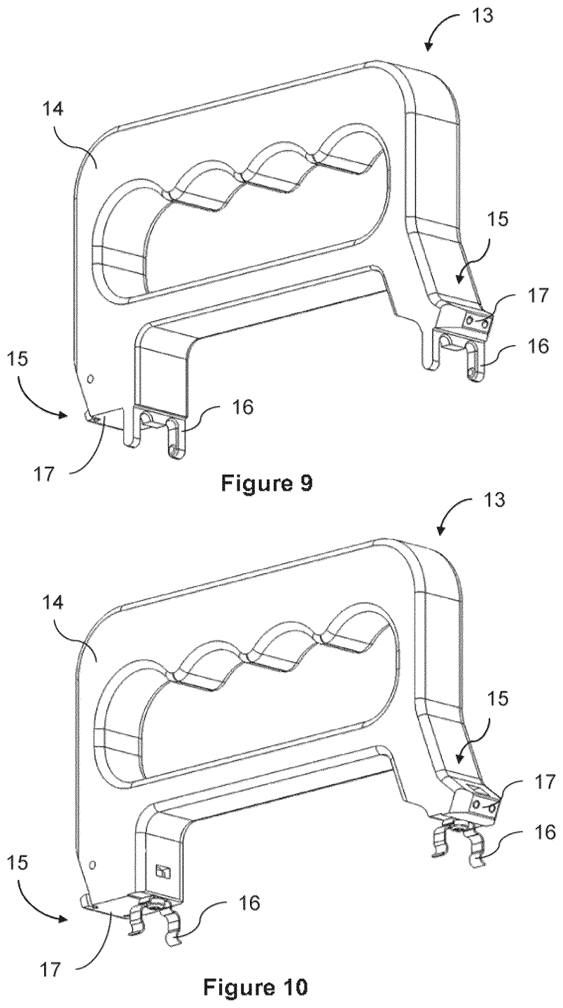

FIGS. 9 and 10 show that each holding section 15 of device 13 comprises a clamp 16 and a support section 17. Clamp 16 is provided to hold universal joint 8 in an anti-rotation manner, while support section 17 is provided to support bearing 2 in an anti-rotation manner. In the embodiment shown in FIG. 9, clamp 16 is integrally connected to main body 14. The embodiment shown in FIG. 10 provides a clamp 16 that is attached to main body 14 in a detachable manner.

1-19. (canceled)

20. A mounting assembly for articulated mounting an actuator in a positioning device, the mounting assembly comprising:
a joint device configured to be coupled to said actuator;
a bearing that supports said joint device; and
a bearing seat that is connected to said bearing in a detachable manner,
wherein said bearing and said bearing seat are configured as complementary male and female coupling sections that are movable between an uncoupled state and a coupled state and, in the coupled state, interact in a positive-fit manner at least in sections, and
wherein said bearing forms said male coupling section and said bearing seat forms said female coupling section.

21. The mounting assembly according to claim 20, wherein
said female coupling section forms a housing for receiving said male coupling section, and
said housing encloses said male coupling section at least in sections in the coupled state.

22. The mounting assembly according to claim 20, wherein
said mounting assembly comprises at least one securing device for securing said bearing and said bearing seat to one another in the coupled state, and
said securing device comprises:
a spring device as a primary securing device, to force said bearing and said bearing seat into the coupled state in a spring-loaded manner; and/or
a locking device as a secondary securing device, to lock all degrees of freedom of motion of said bearing relative to said bearing seat in a positive-fit manner in the coupled state, wherein said locking device acts in a force-fit manner.

23. The mounting assembly according to claim 20, wherein
said bearing comprises a flat contact surface which, in the coupled state, is in contact with a flat contact surface of said bearing seat, and
said bearing abuts against at least one abutment section of said bearing seat which protrudes beyond said contact surface of said bearing seat and is aligned perpendicular to said contact surface of said bearing seat.

24. The mounting assembly according to claim 20, wherein
said bearing is drawn against a first abutment section of said bearing seat by a screw and/or is pressed against a second abutment section of said bearing seat using a spring, and
said first abutment section and said second abutment section of said bearing seat are aligned perpendicular to one another.

25. The mounting assembly according to claim 20, wherein
said joint device is configured as a universal joint with two non-parallel joint axes, and
one of said joint axes is supported by said bearing and the other of said joint axes is configured to be coupled to said actuator.

26. The mounting assembly according to the claim 25, wherein
said bearing comprises two oppositely disposed axis seats, each of which receives an end section of said supported joint axis of said universal joint.

27. The mounting assembly according to claim 25, wherein
said bearing receives said supported joint axis of said universal joint in a force-fit manner by clamping, and/or is connected to said supported joint axis of said universal joint in a positive substance-fit manner by adhesive bonding or welding.

28. The mounting assembly according to claim 25, wherein
said bearing comprises at least one multi-part axis seat, the parts of which are connected to one another by at least one screw connection for clamping an end section of said supported joint axis of said universal joint, and
a longitudinal axis of said screw connection encloses an angle other than 90° with a flat contact surface of said bearing.

29. A positioning device comprising:
a base;
an object carrier; and
at least one actuator arranged between said base and said object carrier,
wherein said at least one actuator is connected to said base or said object carrier by said mounting assembly according to claim 20.

30. The positioning device according to claim 29, wherein
said bearing seat is formed integrally with said base or said object carrier.

31. The positioning device according to claim 30, wherein
said bearing seat is formed as a recess in the surface of said base on an actuator side or in the surface of said object carrier on the actuator side.

32. The positioning device according to claim 29, wherein
said bearing is connected to said bearing seat by at least one screw connection having a longitudinal axis aligned within an angular range of +/−50° to an orthogonal line of a main axis of said positioning device.

33. The positioning device according to claim 31, wherein
said bearing seat is configured as said recess, and said recess extends beyond an edge of said base or said object carrier.

34. The positioning device according to claim 29, wherein
said positioning device is a parallel kinematic positioning device.

35. A device for mounting an actuator in a positioning device for producing a mounting assembly according to claim 20, comprising:
a main body configured as a handle; and
at least one holding section which is connected to said main body and is configured to hold said joint device which is coupled to said bearing and to said actuator and to hold said bearing in a rotationally locked manner.

36. The device according to claim 35, wherein
said holding section comprises a clamp and a support section,
said clamp is configured to hold said joint device in a rotationally locked manner, and
said support section is configured to support said bearing in a rotationally locked manner.

37. The device according to the claim 36, wherein
said clamp is integrally connected to said main body or is attached to said main body in a detachable manner.
